(19) United States
(12) Patent Application Publication
(10) Pub. No.: US 2015/0095771 A1
(43) Pub. Date: Apr. 2, 2015

(54) JOURNAL LAUNCH BASED ON CONTEXT

(71) Applicant: Lenovo (Singapore) Pte. Ltd., Singapore (SG)

(72) Inventors: Elif Karakaya, Raleigh, NC (US); Howard J. Locker, Cary, NC (US); Matthew Lloyd Hagenbuch, Durham, NC (US); Matthew Price Roper, Raleigh, NC (US)

(73) Assignee: Lenovo (Singapore) Pte. Ltd., Singapore (SG)

(21) Appl. No.: 14/042,570

(22) Filed: Sep. 30, 2013

(51) Int. Cl. G06F 17/21

(52) U.S. Cl. CPC G06F 17/212
USPC 715/273

(57) ABSTRACT

A system and method include determining a context of a user via a mobile device having a processor and a memory device, selecting a journal using the processor based on the determined context of the user, determining an application corresponding to the journal using the processor, and opening the selected journal in the loaded application using the processor.

### BACKGROUND

Many people utilize devices to take notes or keep journals for different subjects and different meetings. A user of the device has to either have journal application up and running, or start it when the need to enter information in the journal, referred to as journaling, arises. Further, some people keep separate journals for different subjects or meetings, and must find and open the correct journal. To further complicate matters, the separate journals may utilize different applications which have to be started prior to journaling.

### SUMMARY

A system and method include determining a context of a user via a mobile device having a processor and a memory device, selecting a journal using the processor based on the determined context of the user, determining an application corresponding to the journal using the processor, and opening the selected journal in the loaded application using the processor.

An information handling system readable storage device having instructions for execution by a processor of the information handling system to perform determining a context of a user via a mobile device having a processor and a memory device, selecting a journal using the processor based on the determined context of the user, determining an application corresponding to the journal using the processor, and opening the selected journal in the loaded application using the processor.

A device includes a context sensor to determine a context of a user. A processor is coupled to receive information from the context sensor representative of the context of the user. A memory device includes a journal selection program and is operatively coupled to the processor. The journal selection program is executable by the processor to select a journal based on the received context information, determine an application corresponding to the journal, and open the selected journal for use by the user.

### BRIEF DESCRIPTION OF THE DRAWINGS

FIG. 1 is a block diagram of a mobile device for automatically opening journals based on user context according to an example embodiment.

FIG. 2 is a flowchart illustrating a method of automatically opening journals based on user context according to an example embodiment.

FIG. 3 is a block diagram of an example system for implementing one or more devices and methods.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Various devices may be used for writing or note taking purposes related to various subjects, meetings, and other activities. Such note taking or other data entry related to these activities may be referred to as journaling. Some devices may be dedicated for writing and note taking purposes. In other cases, a hand writing, note taking application may be used on a device along with other applications. The term application is intended to cover small applications commonly referred to as apps in the mobile device environment. Using such applications or a dedicated device, a user may create and save different journals for different subjects, meetings, and other activities.

In various embodiments, the most convenient journal among the many journals saved by the user may be identified based on the context of the user. The selection of the most convenient journal is based on the current condition that the user is in. The identified journal and optionally a corresponding journaling application may be automatically launched by the time the user needs to reach and write to it. As a result, within the many journal files that the user has, the user does not have to go through the trouble of finding the journal that contains prior notes related to a current or soon occurring activity giving rise to a need or desire to journal.

Various embodiments automatically launch a journal based on context information. A specific journal file may be automatically launched based on contextual information that is received and compiled by a system. The contextual information may include information related to at least one of the location of a user at that moment, calendar/schedule information, ambient information, and information about the people around the user. Another aspect that may be taken into account includes a user's past preference history of which journal was previously used in a similar context, such as during a certain event or at a certain location.

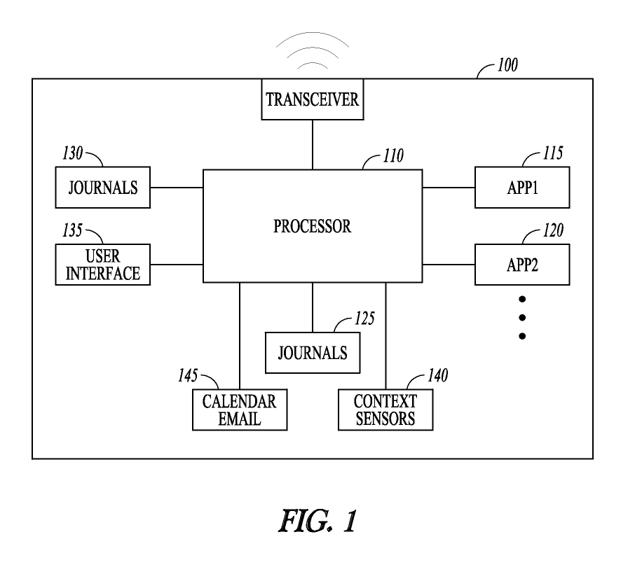

FIG. 1 is a block diagram of a system 100 for automatically launching a journal based on context information. System 100 in various embodiments may be a device, such as a mobile device, or may include a mobile device and remote system in communication with the mobile device to implement one or more methods to provide the context based journal launch functions.

System 100 in one embodiment includes a processor 110 and one or more applications, referred to as apps 115, 120 to execute on the processor 110. The apps operate to provide journaling functions such as editing to one or more journals indicated at 125. A journal selection algorithm 130 is used by the processor 110 to select the journal 125 to open for journaling by a user via a user interface 135. The user interface may include a display or touch sensitive display allowing text and drawing input, a keyboard for text entry, a microphone for recording and speech input, and a speaker in various embodiments.

Context may be provided in multiple different ways. One or more device sensors 140 may include a global positioning system sensor, accelerometers, pressure sensors, temperature, ambient light sensor, and other sensors that provide environmental context information. Further context information may be obtained from a calendar and email application 145 to provide expected location based on schedule and other information which may be relevant to selection of a journal.

In one embodiment, system 100 has access to context information via the device sensors 140 and also via electronic calendar and email account of the user. Hence, the journal selection algorithm 130 can decide on the most convenient journal, the journal that the user created at a similar condition, or specifically created for that purpose, or assigned to be launched when a certain event happens.

For example, a student who has created a separate notebook for each of the classes being attended will have a class schedule that is saved in their device at calendar 145. The system 100 will bring up a specific-subject journal, such as a notebook for an upcoming class just as the student is entering to that class both based on the location and the schedule information of the student. In further embodiments, system 100 may record that the user brings up class journals ten minutes prior to class, and may proceed to utilize that information to bring up a journal just prior to or at 10 minutes prior to a scheduled class.

Similarly, system 100 may detect another user going into the grocery store and bring up a shopping list/to do list that the user had previously created.

In another example, the system 100 recognizes that the user is going to sleep via the ambient light sensor, etc. and brings up a dream diary.

Depending on the contextual information gathered by the mobile device, the system determines the most convenient journal that would be written or recorded into in that condition. In the cases where the system wants to suggest more than one journal, the options could be brought up and once the user selects the most applicable journal, that selection could be saved for future use.

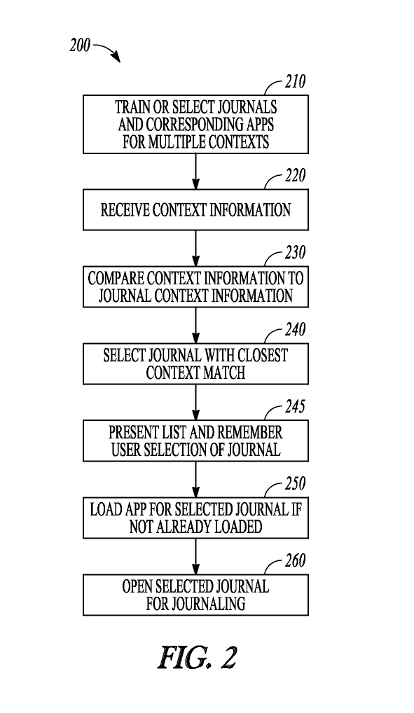

FIG. 2 is a flowchart 200 illustrating a method for journal selection implemented by processor 110 running journal selection algorithm 130. In some embodiments, functions may be performed by a server or cloud based system wirelessly coupled to a user device. At 210, the system is trained. The training may be done various ways. In one embodiment, the system notes which journals and corresponding applications are opened, noting the context when a journal is opened for use. The system may utilize any of the sources of context information, or may select just one or two context data points, such as a schedule for a class. A journal may then be associated with the class, and opened just prior to the class beginning. A second context data point, such as location may also be tracked, and used to determine whether the class is being skipped. Many other context data points may be used and further associated with whether or not to open the journal corresponding to the class. Thus, a context may be very simple, or more complex in different embodiments, and the system learns whether or not to open each journal based on the context data points.

In a further embodiment, a user or programmer may select context data points for each journal, such as by indicating that a calendar event should cause initiation of opening an identified journal. The user or programmer may also add location as a further context data point to key off of as described above. The user or programmer may be provided a list of context data points for each journal to select from as each journal is opened for use. The user would then simply select the context data points desired to cause the journal to automatically load. Logical operators may be provided in further embodiments. The corresponding applications may be selected based on file extensions or other identifiers in further embodiments.

Once the system has been trained or programmed, a method proceeds with determining which journal to open. At 220, context information is received from one or more sensors or other applications. At 230, the context information is compared to the journal context generated from 210. The journal that is associated with context information that closely matches, or exactly corresponds to the received context information is then selected at 240.

Training may continue at 245, by providing the user with a list of journals to select from. If there is more than one matching journal for a current context, the user is presented with a list of journals having contexts that most closely matches the current context. The user may select one of the journals (the one that the user intended to have), and the system records the choice and adds the chosen journal to the context information as a “previously preferred choice for that context.” The next time the context is encountered, the system determines that the user picked that journal will most likely want this one for the next time. The system may then automatically open that journal.

Once the journal is selected, an application corresponding to the selected journal is loaded if not already loaded at 250. Once opened, the selected journal is opened for use, such as journaling at 260.

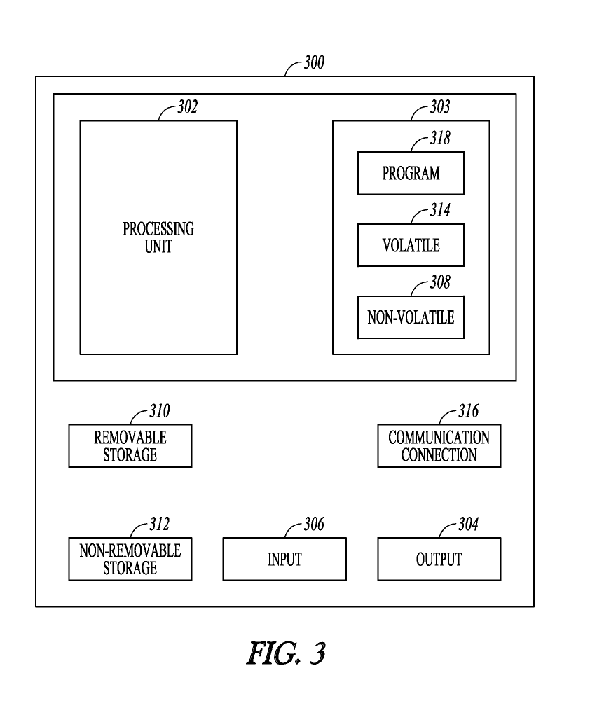

FIG. 3 is a block schematic diagram of a computer system 300 to implement various embodiments, such as mobile devices and remote servers. In one embodiment, multiple such computer systems are utilized in a distributed network. An object-oriented, service-oriented, or other architecture may be used to implement such functions and communicate between the multiple systems and components. One example computing device in the form of a computer 300, may include a processing unit 302, memory 303, removable storage 310, and non-removable storage 312. Memory 303 may include volatile memory 314 and non-volatile memory 308. Computer 300 may include—or have access to a computing environment that includes—a variety of computer-readable media, such as volatile memory 314 and non-volatile memory 308, removable storage 310 and non-removable storage 312. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 300 may include or have access to a computing environment that includes input 306, output 304, and a communication connection 316. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 302 of the computer 300. A hard drive, CD-ROM, and RAM are some examples of articles including a non-transitory computer-readable medium. For example, a computer program 318 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 300 to provide generic access controls in a COM based computer network system having multiple users and servers.

### EXAMPLES

1. A method comprising:
determining a context of a user via a mobile device having a processor and a memory device;
selecting a journal using the processor based on the determined context of the user;
determining an application corresponding to the journal using the processor; and
opening the selected journal in the loaded application using the processor.

2. The method of example 1 wherein the context is determined via a sensor of the mobile device.

3. The method of example 2 wherein the sensor is a global positioning system sensor.

4. The method of any of examples 2-3 wherein the sensor is a light sensor, and wherein a journal is associated with low ambient light detected by the light sensor.

5. The method of example 4 wherein the journal is opened when low ambient light is detected and when a time is proximate a known normal bed time of the user.

6. The method of any of examples 1-5 wherein a journal is selected based on a context of the user, wherein said context is selected from the group consisting of time, location, and a calendar event.

7. The method of example 6 wherein the calendar event is a class scheduled for a certain date and time, and wherein a journal associated with the class is opened if the user is in a location where the journal is normally opened for that class.

8. The method of any of examples 1-7 wherein a journal comprises a grocery list is selected based on a context of the user that includes location corresponding to a grocery store.

9. The method of any of examples 1-8 and further comprising training a journal selection algorithm stored on the memory device with patterns of context corresponded to different journals.

10. The method of example 9 wherein the training comprises determining a context when a journal is opened by the user and associating that context with the journal.

11. An information handling system readable storage device having instructions for execution by a processor of the information handling system to perform:
determining a context of a user via a mobile device having a processor and a memory device;
selecting a journal using the processor based on the determined context of the user;
determining an application corresponding to the journal using the processor; and
opening the selected journal in the loaded application using the processor.

12. The storage device of example 11 wherein the context is determined via a sensor of the mobile device.

13. The storage of example 12 wherein the sensor is a global positioning system sensor.

14. The storage device of any of examples 11-13 wherein a journal is selected based on a context of the user, wherein said context is selected from the group consisting of time, location, and a calendar event, wherein the calendar event is a class scheduled for a certain date and time, and wherein a journal associated with the class is opened if the user is in a location where the journal is normally opened for that class.

15. The storage device of any of examples 11-14 wherein the processor further performs:

training a journal selection algorithm stored on the storage device with patterns of context corresponded to different journals, wherein the training comprises determining a context when a journal is opened by the user and associating that context with the journal.

16. A device comprising:
a context sensor to determine a context of a user;
a processor coupled to receive information from the context sensor representative of the context of the user
a memory device having a journal selection program, the memory device operatively coupled to the processor, wherein the journal selection program is executable by the processor to:
select a journal based on the received context information;
determine an application corresponding to the journal; and
open the selected journal for use by the user.

17. The device of example 16 and further comprising a user interface including a display screen.

18. The device of any of examples 16-17 and further comprising a transceiver to communicate with a remote server.

19. The device of example 18 wherein the device server matches patterns of context information to patterns of context information associated with multiple journals.

20. The device of any of examples 16-19 wherein the context sensor includes a global positioning system sensor.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
determining a context of a user via a mobile device having a processor and a memory device;
selecting a journal using the processor based on the determined context of the user;
determining an application corresponding to the journal using the processor; and
opening the selected journal in the loaded application using the processor.

2. The method of claim 1 wherein the context is determined via a sensor of the mobile device.

3. The method of claim 2 wherein the sensor is a global positioning system sensor.

4. The method of claim 2 wherein the sensor is a light sensor, and wherein a journal is associated with low ambient light detected by the light sensor.

5. The method of claim 4 wherein the journal is opened when low ambient light is detected and when a time is proximate a known normal bed time of the user.

6. The method of claim 1 wherein a journal is selected based on a context of the user, wherein said context is selected from the group consisting of time, location, and a calendar event.

7. The method of claim 6 wherein the calendar event is a class scheduled for a certain date and time, and wherein a journal associated with the class is opened if the user is in a location where the journal is normally opened for that class.

8. The method of claim 1 wherein a journal comprises a grocery list selected based on a context of the user that includes location corresponding to a grocery store.

9. The method of claim 1 and further comprising training a journal selection algorithm stored on the memory device with patterns of context corresponded to different journals.

10. The method of claim 9 wherein the training comprises determining a context when a journal is opened by the user and associating that context with the journal.

11. The method of claim 1 and further comprising ensuring the determined application is loaded in the memory device using the processor prior to opening the selected journal.

11. An information handling system readable storage device having instructions for execution by a processor of the information handling system to perform:
determining a context of a user via a mobile device having a processor and a memory device;
selecting a journal using the processor based on the determined context of the user;
determining an application corresponding to the journal using the processor; and
opening the selected journal in the loaded application using the processor.

13. The storage device of claim 12 wherein the context is determined via a sensor of the mobile device.

14. The storage device of claim 12 wherein a journal is selected based on a context of the user, wherein said context is selected from the group consisting of time, location, and a calendar event, wherein the calendar event is a class scheduled for a certain date and time, and wherein a journal associated with the class is opened if the user is in a location where the journal is normally opened for that class.

15. The storage device of claim 12 wherein the processor further performs:
training a journal selection algorithm stored on the storage device with patterns of context corresponded to different journals, wherein the training comprises determining a context when a journal is opened by the user and associating that context with the journal.

16. A device comprising:
a context sensor to determine a context of a user;
a processor coupled to receive information from the context sensor representative of the context of the user
a memory device having a journal selection program, the memory device operatively coupled to the processor, wherein the journal selection program is executable by the processor to:
select a journal based on the received context information;
determine an application corresponding to the journal; and
open the selected journal for use by the user.

17. The device of claim 16 and further comprising a user interface including a display screen.

18. The device of claim 16 and further comprising a transceiver to communicate with a remote server.

19. The device of claim 18 wherein the device server matches patterns of context information to patterns of context information associated with multiple journals.

20. The device of claim 16 wherein the context sensor includes a global positioning system sensor.
